(19) United States
(12) Patent Application Publication
(10) Pub. No.: US 2022/0288735 A1
(43) Pub. Date: Sep. 15, 2022

(54) TOOL POT

(71) Applicant: OKUMA CORPORATION, Niwa-gun (JP)

(72) Inventor: Makoto Yoshida, Niwa-gun (JP)

(73) Assignee: OKUMA CORPORATION, Niwa-gun (JP)

(21) Appl. No.: 17/692,251

(22) Filed: Mar. 11, 2022

(30) Foreign Application Priority Data
Mar. 12, 2021 (JP) 2021-040665

(51) Int. Cl. B23Q 3/157; B23Q 3/155

(52) U.S. Cl. CPC B23Q 3/1574; B23Q 3/15539; B23Q 3/15773; B23Q 3/15724; B23Q 2003/155411

(57) ABSTRACT

Provided is a tool pot overcoming a problem that dirt adhered to the tool pot is transferred to a contact face of a tool. A pull stud holder includes a pusher that moves in a direction orthogonal to an axis of the tool whereby a tapered face provided at a distal end of the pusher pushes a tapered face of a pull stud in an axial direction of the tool. A base member includes a pull stud receiver that receives an end face of the pull stud. The pusher and the pull stud receiver prevent rotation of the pull stud and movement thereof in the axial direction of the tool. A flange holder includes a key that fits into a keyway of a flange, thereby preventing rotation of the flange.

### DETAILED DESCRIPTION OF THE PRESENT INVENTION

### Technical Field

The present invention relates to a tool pot that holds a tool in a machine tool such as a machining center having an automatic tool changing function.

### Background Art

In this description, the term “tool” means a tool as a single component in some cases, and also means a combination of a tool as a single component and a tool holder to which the tool is attached in other cases.

For example, in automatic tool changers of machining centers, as a tool pot used in a ready station for transferring a tool between a tool magazine and a tool changing arm, or as a tool pot used in a tool magazine, a conventionally known tool pot is configured to accommodate a tool in a hole having a tapered shape that is in conformity with a tapered shape of a tapered shank of the tool, and to pull a pull stud of the tool thereby holding the tool.

In such a tool pot, in a case of performing a tool change by pulling out and inserting the tapered shank and the pull stud in an axial direction of the tool, a stroke for the pulling out and the insertion needs to be longer than a combined length of the tapered shank and the pull stud. This causes problems that a large space is required and that a long time is required for the tool change. In order to solve these problems, Patent Literature 1 discloses a tool pot with which the stroke is shortened, which is accomplished by allowing the tool to be removed sideways after the pull stud is moved in the axial direction of the tool.

### CITATION LIST

### Patent Literature

Patent Literature 1: Japanese Patent No. 3837629

### SUMMARY OF THE INVENTION

### Problem to be Solved by the Invention

According to the conventional tool pot that performs a tool change by pulling out and inserting the tapered shank and the pull stud in the axial direction of the tool, because of the structure that the tapered shank and a flange contact with the tool pot, there has been a problem that dirt adhered to the tool pot is transferred to a contact face of the tool, which causes a risk of defective machining when the tool is mounted on a spindle. In Patent Literature 1, four portions having a circular arc cross section, which are referred to as guide members, are provided, and each of these portions is designed to have surface contact with an outer peripheral part of the flange. This configuration fails to overcome the problem of defective machining caused by dirt adhered to the tool pot being transferred to the contact face of the tool.

An object of the present invention is to provide a tool pot that overcomes the problem that dirt adhered to the tool pot is transferred to the contact faces of a tapered face and a flange end face of the tool.

Another object of the present invention is to provide a tool pot capable of shortening the stroke for mounting/dismounting the tool, and additionally overcoming the problem that dirt adhered to the tool pot is transferred to the contact face of the tool.

### Means for Solving the Problem

The tool pot of the present invention is a tool pot configured to hold a tool in a machine tool having an automatic tool changing function, and including: a pull stud holder configured to hold a pull stud of the tool; a base member; and a flange holder configured to hold a flange of the tool. The pull stud holder includes a pusher configured to move in a direction orthogonal to an axis of the tool whereby an abutment part provided at a distal end of the pusher pushes a tapered face provided at the pull stud in an axial direction of the tool. The base member includes a pull stud receiver configured to receive an end face of the pull stud. The pusher and the pull stud receiver prevent rotation of the pull stud and movement of the pull stud in the axial direction of the tool. The flange holder includes a key configured to fit into a keyway provided at the flange of the tool, and the key prevents rotation of the flange holder.

In order to mount the tool on the tool pot of the present invention, firstly, the tool pot is caused to move toward the tool side in a state where the pusher is located at a retreat position. This causes the key to fit into the keyway provided at the flange of the tool whereby rotation of the tool pot is prevented. Next, the pusher is caused to move to an advance position. The pusher, in a state where its abutment part is abutted against the tapered face of the pull stud, moves in the direction orthogonal to the axis of the tool. The abutment part of the pusher and the tapered face of the pull stud press against each other whereby the pull stud is caused to move in a direction approaching the pull stud receiver of the base member. This causes the end face of the pull stud to abut against the pull stud receiver whereby movement of the tool in the axial direction is prevented.

Here, the abutment part of the pusher is, for example, formed as a tapered face having the same taper angle as that of the tapered face of the pull stud. However, the present invention is not limited thereto.

When the tool is to be removed, the pusher is caused to move to the retreat position whereby the tool becomes movable in the axial direction. Therefore, by moving the tool pot to a position where the key is disengaged from the keyway, the tool becomes rotatable (also movable in the axial direction of the tool). The tool pot is moved in the axial direction of the tool to a position where there exist no obstacles for movement in the direction orthogonal to the axis of the tool, and the tool is moved in a direction orthogonal to the axis of the tool, whereby removal of the tool from the tool pot is completed.

With the tool pot of the present invention, the pull stud holder prevents movement of the pull stud in the axial direction of the tool, and the key of the flange holder prevents rotation of the flange holder. Therefore, there is no need to have surface contact with the tapered shank or the flange end face part of the tool to hold them, and dirt adhered to the tool pot will not be adhered to the outer peripheral face of the tapered shank and to the outer peripheral face or the end face of the flange of the tool, which results in elimination of defective machining caused by dirt adhered when the tool is mounted on the spindle.

The flange holder preferably includes, in addition to the key, a pair of supports both located 90 degrees or more away from the key clockwise and counterclockwise, respectively, and facing the outer peripheral part of the flange. The pair of supports each have a pin shape, for example, so that the supports do not have surface contact over a large area. The flange holder thus holds the flange from the outer diameter side at three locations, i.e., at the pair of supports and the key. With this configuration, the flange is reliably held.

It is preferable that the key and the supports of the flange holder are provided on an opposed member that faces the base member provided with the pull stud receiver, that the opposed member has a circular through hole through which the tapered shank of the tool is inserted, and that the through hole has an opening that is open toward the direction orthogonal to the axis of the tool.

With this configuration, by causing the tapered shank of the tool to pass through the opening provided at the through hole of the opposed member, movement in the direction orthogonal to the axis of the tool is allowed, whereby the stroke of the tool pot for the linear movement relative to the tool at the time of mounting/dismounting the tool is shortened, the space required for mounting/dismounting the tool becomes relatively small, and, in addition, the time required for mounting/dismounting the tool is shortened.

### Advantageous Effects of the Invention

With the tool pot of the present invention, the problem that dirt adhered to the tool pot is transferred to the contact face of the tapered face and the flange end face of the tool is overcome.

### BRIEF DESCRIPTION OF THE DRAWINGS

FIG. 1 is a perspective view showing a tool pot according to an embodiment of the present invention.

FIG. 2 is a partially broken away vertical cross-sectional view showing a state before the tool is held, according to the embodiment of the present invention.

FIG. 3 is a partially broken away vertical cross-sectional view showing a state where the tool is held, according to the embodiment of the present invention.

FIG. 4 is a transverse cross-sectional view of a main part, according to the embodiment of the present invention.

FIG. 5(a) is a partially broken away vertical cross-sectional view showing, in an enlarged manner, a state immediately before the tool is held, according to the embodiment of the present invention. FIG. 5(b) is a partially broken away vertical cross-sectional view showing, in an enlarged manner, a state where the tool is held, according to the embodiment of the present invention.

### DESCRIPTION OF EMBODIMENTS

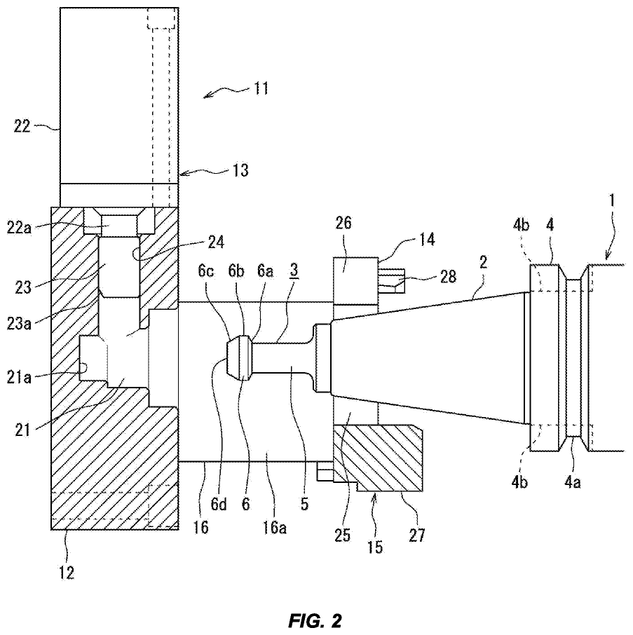

The embodiments of the present invention will be described below, with reference to the drawings. In the following description, the right side and the left side of FIG. 2 are referred to as front and rear, respectively, and, likewise, the upper side and the lower side are referred to as left and right, respectively.

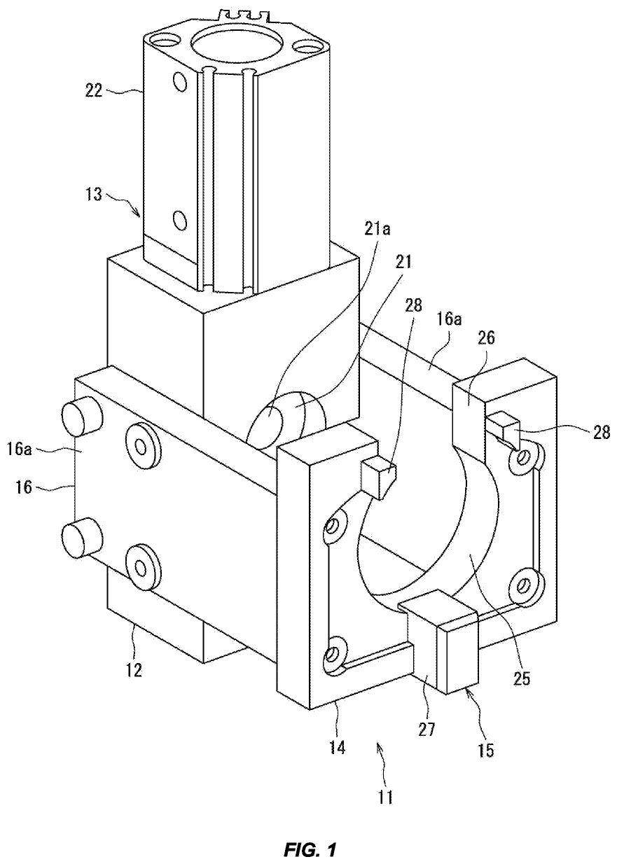

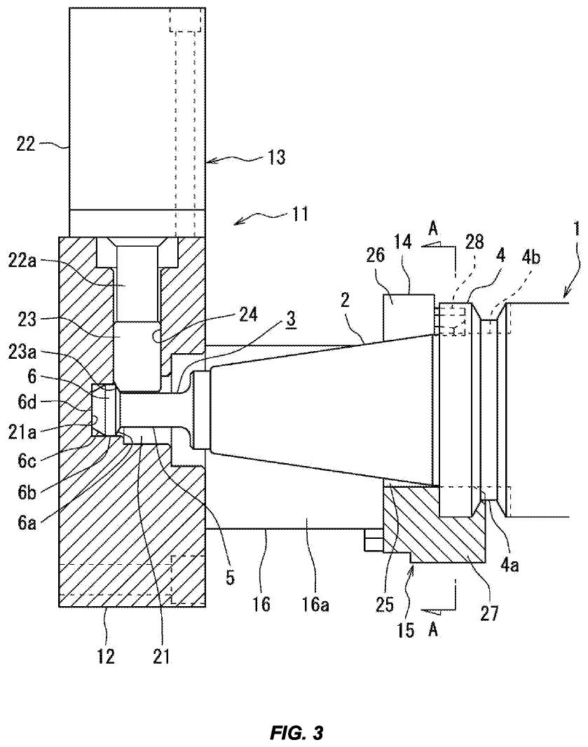

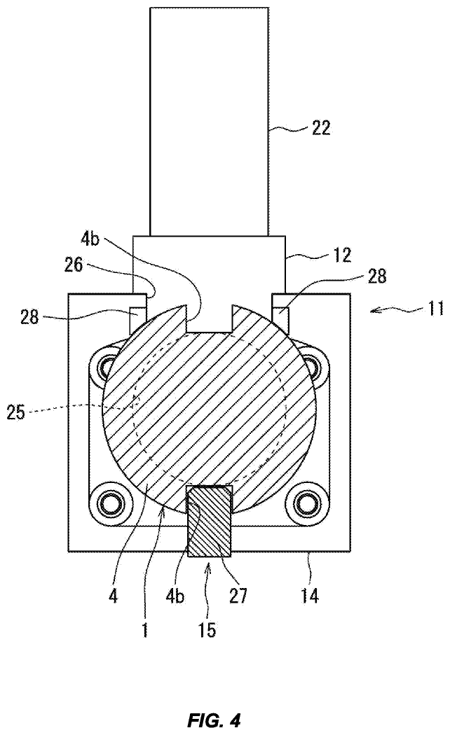

FIG. 1 shows a tool pot (11) only, and FIG. 2 and FIG. 3 each show the tool pot (11) together with a tool (1). The tool pot (11) is used, for example, in an automatic tool changer of a machining center, when the tool (1) is delivered between a tool magazine and a tool changing arm.

The tool (1) has: a tapered shank (2) whose outer peripheral face is a tapered face; a pull stud (3) provided at a small-diameter-side end of the tapered shank (2); and a flange (4) provided at a large-diameter-side end of the tapered shank (2).

The pull stud (3) consists of: a small-diameter portion (5) adjacent to a distal end of the tapered shank (2); and a large-diameter portion (6) adjacent to the small-diameter portion (5). The large-diameter portion (6) consists of: a small-diameter-side tapered part (6a) adjacent to the small-diameter portion (5); a cylindrical part (6b) adjacent to the small-diameter-side tapered part (6a); and an end-face-side tapered part (6c) adjacent to the cylindrical part (6b). The end-face-side tapered part (6c) has an end face (6d) orthogonal to the axial direction of the tool.

The flange (4) is provided with an annular V-groove (4a) having a V-shaped cross section, and a pair of keyways (4b). The pair of keyways (4b) are arranged at locations away from each other at 180 degrees so as to be parallel to the axis.

The tool pot (11) includes: a base member (12) located on a base end side (rear side) thereof; a pull stud holder (13) provided at the base member (12); an opposed member (14) facing the base member (12) and located on a distal end side (front side) thereof; a flange holder (15) provided on the opposed member (14); and a connecting member (16) connecting the base member (12) and the opposed member (14).

The base member (12) has a rectangular parallelepiped block shape, and has a front face (a face facing the opposed member (14)) where a recess (21) accommodating the pull stud (3) is formed so as to be open frontward.

The pull stud holder (13) includes: an air cylinder (22) provided at the left side surface of the base member (12); and a pusher (23) provided at a distal end of a rod (22a) of the air cylinder (22) and configured to push the pull stud (3). The rod (22a) of the air cylinder (22) is capable of advancing and retreating in the left-right direction, and the base member (12) is provided at the left side surface thereof with a recess (24) that allows the pusher (23) to advance and retreat and is open leftward.

The pusher (23) has a tapered face (23a) as an abutment part that abuts against the small-diameter-side tapered part (6a) of the pull stud (3).

The opposed member (14) has a plate-like shape, and has a circular through hole (25) through which the tapered shank (2) is to be inserted. The through hole (25) has an opening (26) that is open leftward.

The flange holder (15) includes: a key (27) located at a position facing the opening (26) and configured to fit into one (keyway (4b) on the right) of the pair of the keyways (4b) of the tool (1); and a pair of supports (28) arranged so as to sandwich the opening (26).

The pair of supports (28) are disposed at positions 90 degrees or more (for example, on the order of 135 degrees) away from the key (27) clockwise and counterclockwise, respectively, so as to face an outer peripheral part of the flange (4). Each support (28) has a pin shape so as not to have surface contact over a large area.

The flange holder (15) is configured to hold the flange (4) from the outer diameter side at three locations, that is, at the key (27) and the pair of supports (28).

The connecting member (16) consists of a pair of plates (16a) arranged so as to sandwich the base member (12). A rear part of each of the plates (16a) is fixed to the base member (12). Each plate (16a) has a front face to which the opposed member (14) is fixed.

The recess (21) accommodating the pull stud (3) is formed to have a stepped shape consisting of: a small-diameter portion on a bottom face (21a) side of the recess (21), a large-diameter portion on an opening side, and an intermediate-diameter portion between the small-diameter portion and the large-diameter portion. The bottom face (21a) of the recess (21) is configured to receive a rear face (6d) of the large-diameter portion (6) of the pull stud (3).

The small-diameter-side tapered part (6a), the cylindrical part (6b), and the end-face-side tapered part (6c) of the pull stud (3) of the tool (1) are all formed such that their centers pass through the axis of the tool (1), whereas the pusher (23) having the tapered face (23a) is formed such that its center passes through the axis orthogonal to the axis of the tool (1).

With the tool pot (11) according to the above-described embodiment, the tool (1) is mounted and dismounted as follows. That is, firstly, in a state where the pusher (23) is located at a retreat position as shown in FIG. 2, the tool pot (11) is moved forward (rightward in FIG. 2, the direction approaching the tool (1)). As shown in FIG. 3, in the flange (4) of the tool (1), this movement causes the key (27) to fit into the keyway (4b) of the flange (4). This fitting prevents relative rotation between the tool pot (11) and the tool (1). At the same time, as shown in FIG. 4, the pair of supports (28) face the outer peripheral part of the flange (4) from the outer diameter side. The flange (4) of the tool (1) is thus held from the outer diameter side at three locations, i.e., at the key (27) and the pair of supports (28), with the rotation being prevented by the key (27).

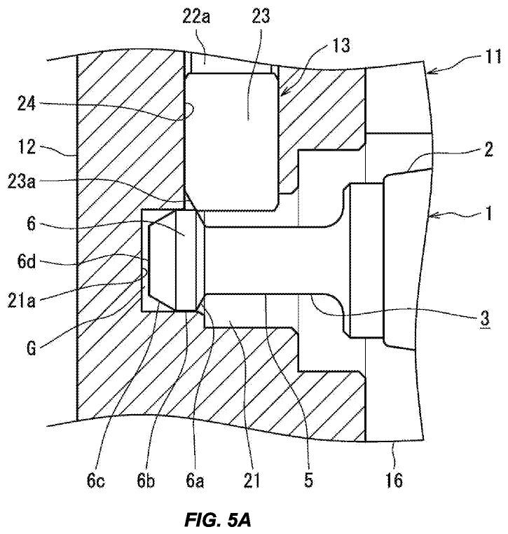

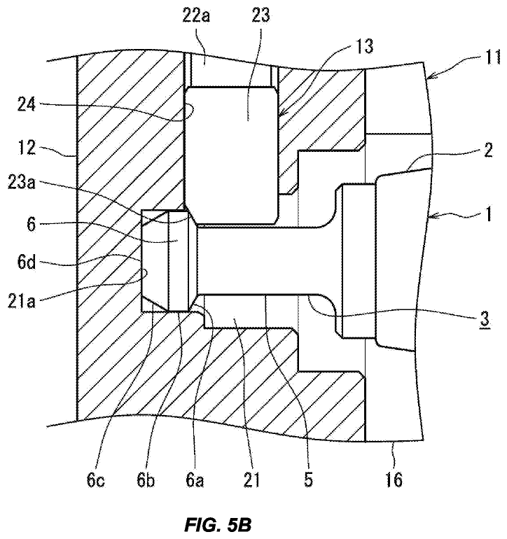

At this time, at the flange (4) of the tool (1), as shown in FIG. 5(a), the end face (6d) of the pull stud (3) faces the bottom face (21a) of the recess (21) with a slight gap (G) interposed therebetween.

In the state as shown in FIG. 5(a), the air cylinder (22) is driven whereby the pusher (23) is moved rightward (advance position). The pusher (23) moves rightward (direction orthogonal to the axis of the tool (1)) with the tapered face (23a) of the pusher (23) abutting against the small-diameter-side tapered face (6a) of the pull stud (3), and the tapered face (23a) and the tapered face (6a) abutting against each other moves the pull stud (3) rearward (direction abutting against the bottom face (21a) of the recess (21)). As shown in FIG. 5(b), this eliminates the gap (G) between the distal end face (6d) of the pull stud (3) and the bottom face (21a) of the recess (21) (the bottom face (21a) of the recess (21) serves as a pull stud receiver), and the pusher (23) pushes the distal end face (6d) of the pull stud (3) strongly against the pull stud receiver (21a). This prevents movement of the tool (1) relative to the tool pot (11) in the axial direction of the tool (1), and at the same time also prevents rotation of the tool (1) relative to the tool pot (11) because fitting the key (27) into the keyway (4b) assists prevention of the rotation. The mounting of the tool (1) on the tool pot (11) is thus completed.

In a case where the tool (1) is to be removed from the tool pot (11), firstly, the pusher (23) is moved to the retreat position as shown in FIG. 2. This allows the tool pot (11) to be movable in a direction away from the tool (1). By moving the tool pot (11) to a position where the key (27) is disengaged from the keyway (4b), the tool pot (11) and the tool (1) becomes rotatable relative to each other. When the tool pot (11) is moved to a position as shown in FIG. 2, the pull stud (3) comes out of the recess (21) to be located at a position not to interfere with the base member (12). By moving the tool (1) in a direction orthogonal to the axis of the tool (1) and by causing the tapered shank (2) to pass through the opening (26) of the through hole (25) provided at the opposed member (14), the tool (1) is removed from the tool pot (11).

With the tool pot (11) of the above-described embodiment, the outer peripheral face of the tapered shank (2) and an outer peripheral face of the flange (4), which are used as a binding face when the tool (1) is clamped to the spindle, have contact at two locations only, i.e., at the pair of supports (28), and therefore the tool pot (11) does not have surface contact with the outer peripheral face of the tapered shank (2) and the end face of the flange (4) of the tool (1). With this configuration, even in a case where dirt exists in the tool pot (11), defective machining caused by dirt adhered when the tool (1) is mounted on the spindle is avoided.

In addition, with the tool pot (11) according to the above-described embodiment, in a state as shown in FIG. 2, by causing the tapered shank (2) of the tool (1) to pass through the opening (26) of the through hole (25) formed at the opposed member (14), even though the front face of the opposed member (14) of the tool pot (1) is not located rearward (leftward in FIG. 2) relative to the rear face of the pull stud (3) of the tool (1) from the state shown in FIG. 2, movement in the direction orthogonal to the axis of the tool (1) is allowed. Therefore, at the time of mounting/dismounting the tool (1), the stroke of the tool pot (11) for the linear movement relative to the tool (1) is shortened, the space required for mounting/dismounting the tool (1) is reduced, and, in addition, the time required for mounting/dismounting the tool (1) is shortened.

In the above description, as an abutment part abutting against the small-diameter-side tapered part (6a) of the pull stud (3) provided at the pusher (23), the tapered face (23a) being in conformity with the corresponding small-diameter-side tapered face (6a) of the pull stud (3) is adopted. However, the abutment part of the pusher (23) may have, instead of the above configuration, other shapes such as being spherical or having a circular arc cross section. As long as the abutment part of the pusher (23) and the tapered face of the pull stud (3) are pushed against each other whereby the pull stud (3) is moved in a direction approaching the pull stud receiver (21a) of the base member (12), the abutment part of the pusher (23) may have any shape among various shapes.

### REFERENCE SIGNS LIST

(1): tool
(2): tapered shank
(3): pull stud
(4): flange
(4b): keyway
(6a): tapered face
(11): tool pot
(12): base member
(13): pull stud holder
(14): opposed member
(15): flange holder
(21a): bottom face of recess (21) (pull stud receiver)
(23): pusher
(23a): tapered face (abutment part)
(25): through hole
(26): opening
(27): key
(28): support

1. A tool pot configured to hold a tool in a machine tool having an automatic tool changing function, the tool pot comprising: a pull stud holder configured to hold a pull stud of the tool; a base member; and a flange holder configured to hold a flange of the tool, wherein
the pull stud holder includes a pusher configured to move in a direction orthogonal to an axis of the tool whereby an abutment part provided at a distal end of the pusher pushes a tapered face provided at the pull stud in an axial direction of the tool, the base member includes a pull stud receiver configured to receive an end face of the pull stud, and the pusher and a pull stud receiver prevent rotation of the pull stud and movement of the pull stud in the axial direction of the tool, and
the flange holder includes a key configured to fit into a keyway provided at the flange of the tool, and the key prevents rotation of the flange holder.

2. The tool pot according to claim 1, wherein the flange holder, comprising: the key; and a pair of supports both located at positions 90 degrees or more away from the key clockwise and counterclockwise, respectively, and facing an outer peripheral part of the flange, is configured to hold the flange from an outer diameter side thereof at three locations, i.e., at the key and the pair of supports.

3. The tool pot according to claim 2, wherein the key and the supports of the flange holder are provided on an opposed member facing the base member provided with the pull stud receiver, the opposed member has a circular through hole through which a tapered shank of the tool is inserted, and the through hole has an opening that is open toward a direction orthogonal to the axis of the tool.
